(19) United States
(12) Patent Application Publication
(10) Pub. No.: US 2025/0209290 A1
(43) Pub. Date: Jun. 26, 2025

(54) STORAGE MEDIUM, PRINT CONTROL METHOD, AND SYSTEM

(71) Applicant: CANON KABUSHIKI KAISHA, Tokyo (JP)

(72) Inventor: Shu KUMAHASHI, Ibaraki (JP)

(21) Appl. No.: 18/981,747

(22) Filed: Dec. 16, 2024

(30) Foreign Application Priority Data
Dec. 26, 2023 (JP) 2023-219984

(51) Int. Cl. G06K 15/02; G06F 3/12

(52) U.S. Cl. CPC G06K 15/1809; G06F 3/1205; G06F 3/1256; G06F 3/1267

(57) ABSTRACT

The present invention relates to a non-transitory computer-readable storage medium storing a computer program for extending a function of a generative AI service. The computer program causes a computer of an information processing apparatus to function so as to upon accepting a print request via the generative AI service, generate a print job based on the print request, and register reservation of the generated print job in a printing server. Further, the computer program causes the information processing apparatus to function so as to acquire information related to a connection destination for executing the reserved print job from the printing server, and present the generated print job and the information related to the connection destination to a user via the generative AI service.

### BACKGROUND OF THE INVENTION

### Field of the Invention

The present invention relates to a storage medium storing a computer program for extending functions of an artificial intelligence system, a print control method, and a system.

### Description of the Related Art

An artificial intelligence system, called generative AI, that can generate text, images, or other media in response to a prompt is known. In generative AI such as ChatGPT®, functions can be extended with plug-ins. For example, when text containing a keyword “print” is inputted as an instruction to the generative AI, a plug-in related to printing is selected, and in place of the generative AI, the plug-in performs processing that cannot be handled by the generative AI, thereby allowing functions to be extended.

Meanwhile, in image forming apparatuses, print data can be inputted from a cloud server and printed. For example, Japanese Patent Laid-Open No. 2018-128843 proposes a technique in which a document managed by a cloud server can be printed through a chat conversation.

However, when printing output, such as text that is generated by generative AI, on an image forming apparatus, a user or the like needs to copy it to a file or the like and execute printing from a print driver or the like. That is, the user needs to copy the output generated by the generative AI in order to execute printing, which is cumbersome.

### SUMMARY OF THE INVENTION

The present invention enables realization of a mechanism for suitably printing output from generative AI on an image forming apparatus.

One aspect of the present invention provides a non-transitory computer-readable storage medium storing a computer program for extending a function of a generative AI service, wherein the computer program is for causing a computer of an information processing apparatus to function so as to: upon accepting a print request via the generative AI service, generate a print job based on the print request; register reservation of the generated print job in a printing server; acquire information related to a connection destination for executing the reserved print job from the printing server; and present the generated print job and the information related to the connection destination to a user via the generative AI service.

Another aspect of the present invention provides a print control method comprising: upon accepting a print request via a generative AI service provided by an information processing apparatus, generating a print job based on the print request; registering reservation of the generated print job in a printing server; acquiring information related to a connection destination for executing the reserved print job from the printing server; and presenting the generated print job and the information related to the connection destination to a user via the generative AI service.

Still another aspect of the present invention provides a printing system including an information processing apparatus providing a generative AI service to a user terminal, a printing server, and an image forming apparatus, the information processing apparatus comprising: one or more first memory devices that store a set of instructions; and one or more first processors that execute the set of instructions to: upon accepting a print request via the generative AI service, generate a print job based on the print request; register reservation of the generated print job in a printing server; acquire information related to a connection destination for executing the reserved print job from the printing server; and present the generated print job and the information related to the connection destination to a user via the generative AI service, and the printing server comprising: one or more second memory devices that store a set of instructions; and one or more second processors that execute the set of instructions to: when the print job is reserved, provide the information related to the connection destination; and when the user accesses the information related to the connection destination, input the print job to the image forming apparatus.

Further features of the present invention will be apparent from the following description of exemplary embodiments with reference to the attached drawings.

### BRIEF DESCRIPTION OF THE DRAWINGS

FIG. 1 is a diagram illustrating a configuration of a system according to one embodiment.

FIG. 2 is a diagram illustrating a configuration of an MFP according to one embodiment.

FIG. 3 is a diagram illustrating a configuration of a user terminal according to one embodiment.

FIG. 4 is a diagram illustrating a configuration of a generative AI server according to one embodiment.

FIG. 5 is a diagram illustrating a configuration of an extension application server according to one embodiment.

FIG. 6 is a diagram illustrating a configuration of a cloud printing server according to one embodiment.

FIG. 7 is a diagram illustrating an example of a screen for interacting with a generative AI server displayed on a user terminal according to one embodiment.

FIGS. 8A-8B are a sequence diagram of document printing according to one embodiment.

FIG. 9 is a flowchart related to an extension application server according to one embodiment.

FIG. 10 is a sequence diagram of reprinting according to one embodiment.

FIG. 11 is a diagram illustrating an example of a response of the generative AI server according to one embodiment.

FIG. 12 is a diagram illustrating an example of a browser screen for when a reserved job URL has expired according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### First Embodiment

### <System Configuration>

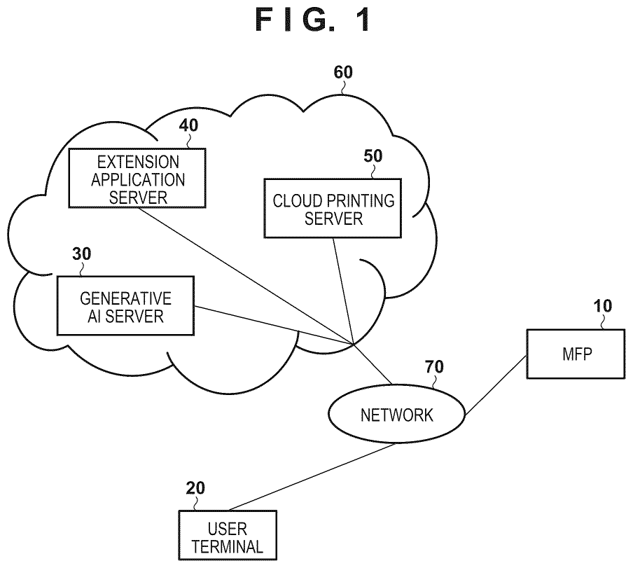

A first embodiment of the present invention will be described below. In the present embodiment, description will be given using a multi function peripheral (MFP) that includes printing, scanning, and FAX functions as an example of an image processing apparatus. FIG. 1 illustrates an example of a diagram of an overall configuration of a printing system that provides a printing service through a generative AI service according to the present invention. The printing system is configured to include an image forming apparatus 10 (e.g., printing apparatus), a user terminal 20, a generative AI server 30, an extension application server 40, and a cloud printing server 50. They are connected so as to be capable of communicating with each other via a network 70. The network 70 is a wireless or wired network constituted by a WAN or a LAN.

The image forming apparatus 10 indicates a printing apparatus that includes a function of printing an image notified from the cloud printing server 50. The user terminal 20 indicates an information terminal such as a smartphone, a tablet terminal, or a personal computer for when a user uses a generative AI service such as ChatGPT. The user accesses the generative AI server 30 on the cloud by operating the user terminal 20 and executes a generative AI application. The user terminal 20 and the generative AI server 30 are connected to a wired or wireless communication network, and each is capable of transmitting and receiving data. In the present embodiment, a public line on the Internet is assumed as an example of a communication network, but a dedicated line may be used.

The generative AI server 30 is a cloud server (information processing apparatus) arranged on the cloud 60, which provides generative AI such as ChatGPT, which is text-generating AI. The generative AI server 30 provides services in cooperation with the extension application server 40. The generative AI server 30 interprets a message transmitted from the user terminal 20, generates an appropriate response, and displays the response on a screen of the user terminal 20. In addition, the generative AI server 30 can extend its functions by communicating with the extension application server 40.

The extension application server 40 is a cloud server (information processing apparatus) arranged on the cloud 60 and includes a function of providing additional functions (plug-ins) to the generative AI server 30. The generative AI server 30 can perform processing that it could not have performed alone by implementing a predetermined plug-in in cooperation with the extension application server 40. The cloud printing server 50, upon receiving a print request from the user terminal 20, notifies the image forming apparatus 10 that a print job has been received. The image forming apparatus 10 receives the print job from the cloud printing server 50 and executes printing according to the notification from the cloud printing server 50. Here, an example in which various servers are provided individually will be described, but each server may be provided so as to be integrated with another server. For example, the generative AI server 30 and the extension application server 40 may be provided in an integrated manner.

### <Hardware Configuration of Image Forming Apparatus>

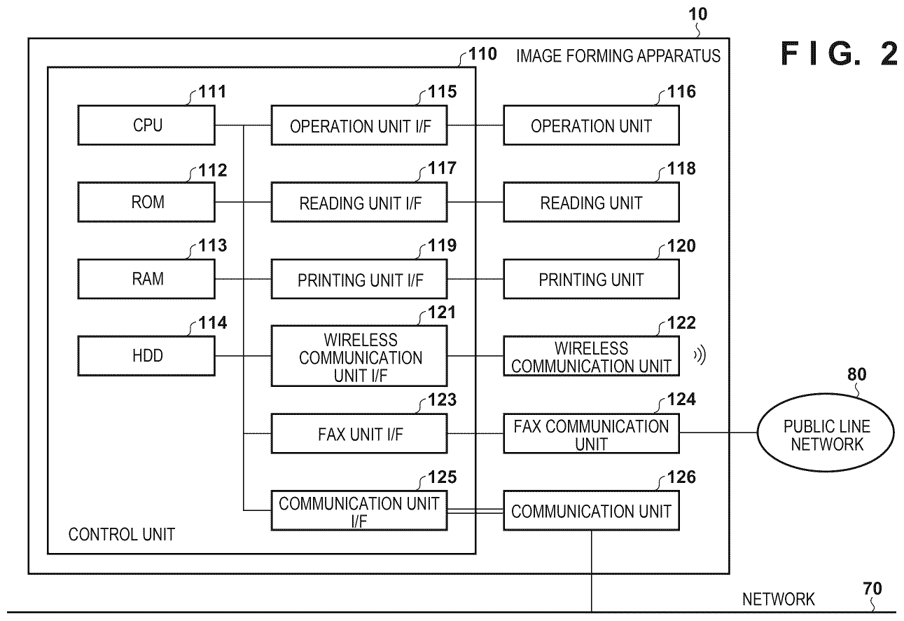

An example of a hardware configuration of the image forming apparatus 10 according to the present embodiment will be described with reference to FIG. 2. The image forming apparatus 10 includes a control unit 110, an operation unit 116, a reading unit 118, a printing unit 120, a wireless communication unit 122, a FAX communication unit 124, and a communication unit 126. The control unit 110 includes a CPU 111, a ROM 112, a RAM 113, an HDD 114, an operation unit I/F 115, a reading unit I/F 117, a printing unit I/F 119, a wireless communication unit I/F 121, a FAX unit I/F 123, and a communication unit I/F 125.

The control unit 110, which includes the CPU 111, controls the operation of the entire image forming apparatus 10. The CPU 111 reads a control program stored in the ROM 112 or the HDD 114 into the RAM 113 and performs various kinds of control such as read control and print control. The ROM 112 stores control programs that can be executed by the CPU 111. The ROM 112 also stores a boot program, font data, and the like. The RAM 113 is a main storage memory and is used as a work area and as a temporary storage area for deploying various control programs stored in the ROM 112 and the HDD 114. The HDD 114 stores image data, print data, various programs, various addresses, and various kinds of setting information. The HDD 114 is a storage medium but need not be an HDD and may be a solid state drive (SSD), an embedded Multi Media Card (eMMC), or the like.

The image forming apparatus 10 according to the present embodiment is assumed to be such that one CPU 111 executes each process indicated in the flowcharts to be described later using one memory (RAM 113), but is not limited thereto. For example, a plurality of CPUs, RAMs, ROMs, and HDDs may cooperate to perform each process. Further, a hardware circuit such as an ASIC or an FPGA may be used to execute some processes.

The operation unit I/F 115 connects the operation unit 116, which includes a display unit (e.g. a touch panel) and a hardware key, and the control unit 110. The operation unit 116 displays information to the user and detects input from the user. The reading unit I/F 117 connects the reading unit 118, such as a scanner, and the control unit 110. The reading unit 118 reads an image of an original document, and the CPU 111 converts that image into image data such as binary data. The image data generated based on the image read by the reading unit 118 is transmitted to an external apparatus or printed on a printing sheet. The printing unit I/F 119 connects the printing unit 120, such as a printer, and the control unit 110. The CPU 111 transfers the image data (print data) stored in the RAM 113 to the printing unit 120 through the printing unit I/F 119. The printing unit 120 prints an image based on the transferred image data on a printing sheet fed from a feeding cassette.

The wireless communication unit I/F 121 is an I/F for controlling the wireless communication unit 122, and wirelessly connects the control unit 110 and an external wireless device. The FAX unit I/F 123 controls the FAX communication unit 124 to connect to a public line network 80. The FAX unit I/F 123 is an I/F for controlling the FAX communication unit 124, and can, for example, connect to a public line network and control a facsimile communication protocol, by controlling a facsimile communication modem, NCU.

The communication unit I/F 125 connects the control unit 110 and the network 70. Regarding the communication unit I/F 125, the communication unit 126 transmits image data and various kinds of information inside the apparatus to an external apparatus on the network 70, and receives print data from an external apparatus on the network 70 and information on the network 70. As a method of performing transmission and reception via the network 70, transmission and reception can be performed using electronic mail (e-mail) and file transmission can be performed using other protocols (e.g., FTP, SMB, WEBDAV, etc.). Image data and message data can also be transmitted and received on the network 70 by access through HTTP communication from the user terminal 20 and the generative AI server 30. In addition, it is possible to access the image forming apparatus 10 via a network from a web browser of the user terminal 20 and perform various settings of the image forming apparatus 10 (remote UI function).

### <Hardware Configuration of User Terminal>

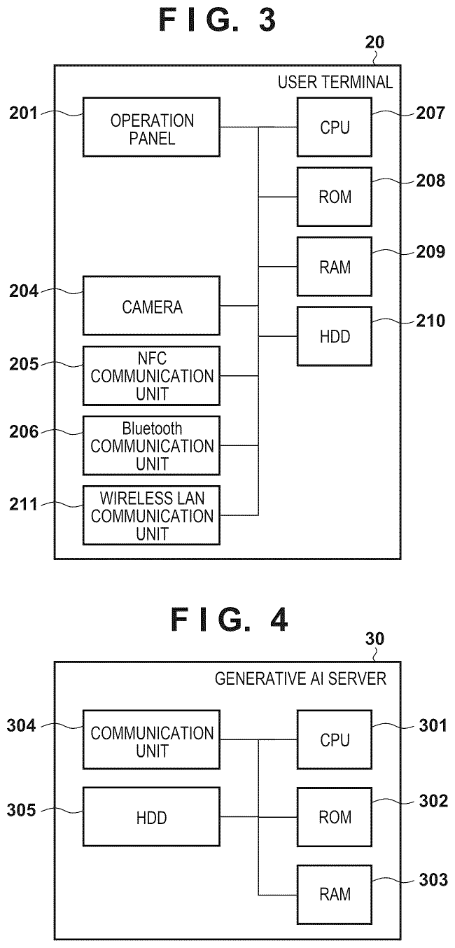

An example of a hardware configuration of the user terminal 20 according to the present embodiment will be described with reference to FIG. 3. The user terminal 20 of the present embodiment is assumed to be an apparatus such as a smart phone or a tablet PC but may be another apparatus so long as it is an information processing apparatus capable of connecting to the network 70 using Wi-Fi communication or the like. The user terminal 20 includes an operation panel 201, a camera 204, an NFC communication unit 205, a Bluetooth® communication unit 206, a CPU 207, a ROM 208, a RAM 209, an HDD 210, and a wireless LAN communication unit 211.

The CPU 207 reads a control program stored in the ROM 208 and executes various processes for controlling the operation of the user terminal 20. The ROM 208 stores the above control program. The RAM 209 is used as a main memory of the CPU 207 and as a temporary storage area such as a work area. The HDD 210 stores various kinds of data such as photos and electronic documents.

The operation panel 201 is provided with a touch panel function capable of detecting the user's touch operation and displays various screens provided by an OS and an electronic mail transmission application. The operation panel 201 is also used to confirm information stored in the generative AI server 30. By inputting a touch operation to the operation panel 201, the user can input a desired operation instruction to the user terminal 20. The user terminal 20 includes a hardware key (not illustrated), and the user can input an operation instruction to the user terminal 20 using the hardware key.

The camera 204 performs imaging according to the user's imaging instruction. A photo captured by the camera 204 is stored in a predetermined region of the HDD 210. In addition, a program capable of analyzing a QR code® can be used to acquire information from a QR code read by the camera 204.

The user terminal 20 can exchange data with various peripheral devices via the NFC communication unit 205, the Bluetooth communication unit 206, and the wireless LAN communication unit 211. The Bluetooth communication unit 206 of the user terminal 20 may support Bluetooth Low Energy (BLE).

### <Hardware Configuration of Generative AI Server>

An example of a hardware configuration of the generative AI server 30 according to the present embodiment will be described with reference to FIG. 4. The generative AI server 30 includes a CPU 301, a ROM 302, a RAM 303, a communication unit 304, and an HDD 305.

The CPU 301 uses a control program stored in the ROM 302 and a learning model stored in the HDD 305 to execute processing for controlling an operation for generating an appropriate response. The ROM 302 stores the above control program. The RAM 303 is used as a main memory of the CPU 301 and as a temporary storage area such as a work area. The HDD 305 stores various kinds of data such as a learning model and a generative AI application.

Data can be exchanged with various devices such as the user terminal 20, the image forming apparatus 10, and the extension application server 40 through the communication unit 304. The communication unit 304 may perform wired communication using Ethernet®, or may perform wireless communication such as Wi-Fi.

### <Hardware Configuration of Extension Application Server>

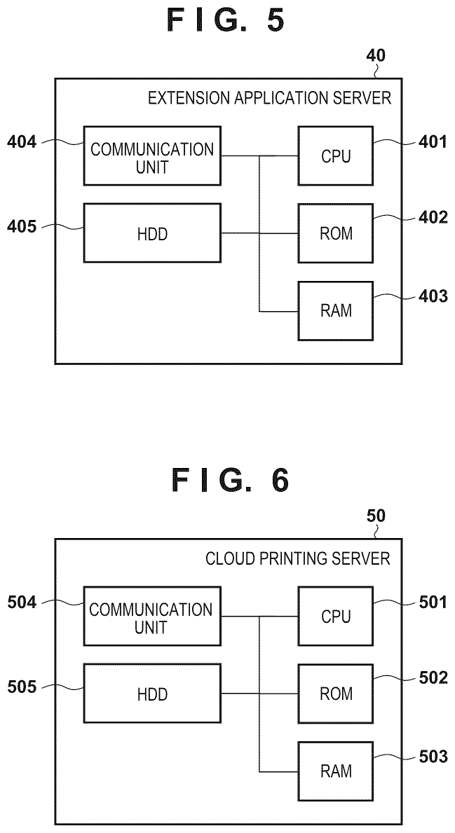

FIG. 5 is a diagram illustrating an example of a hardware configuration of the extension application server 40. The extension application server 40 includes a CPU 401, a ROM 402, a RAM 403, a communication unit 404, and an HDD 405.

The CPU 401 reads a control program stored in the ROM 402 and executes processing according to a message received from the generative AI server 30. The ROM 402 stores the above control program. The RAM 403 is used as a main memory of the CPU 401 and as a temporary storage area such as a work area. The HDD 405 stores content of a message received from the generative AI server 30, a part thereof, and the like. Data can be transmitted and received to and from each device, such as the generative AI server 30, through the communication unit 404.

### <Hardware Configuration of Cloud Printing Server>

FIG. 6 is a diagram illustrating an example of a hardware configuration of the cloud printing server 50. The cloud printing server 50 includes a CPU 501, a ROM 502, a RAM 503, a communication unit 504, and an HDD 505.

The CPU 501 reads a control program stored in the ROM 502, and can thereby receive a print job from the user terminal 20 and acquire a stored print job. The ROM 502 stores the above control program. The RAM 503 is used as a main memory of the CPU 501 and as a temporary storage area such as a work area. The HDD 505 stores, for example, a print job received from the user terminal 20. Data can be transmitted and received to and from each device, such as the generative AI server 30, through the communication unit 504.

### <Print Instruction>

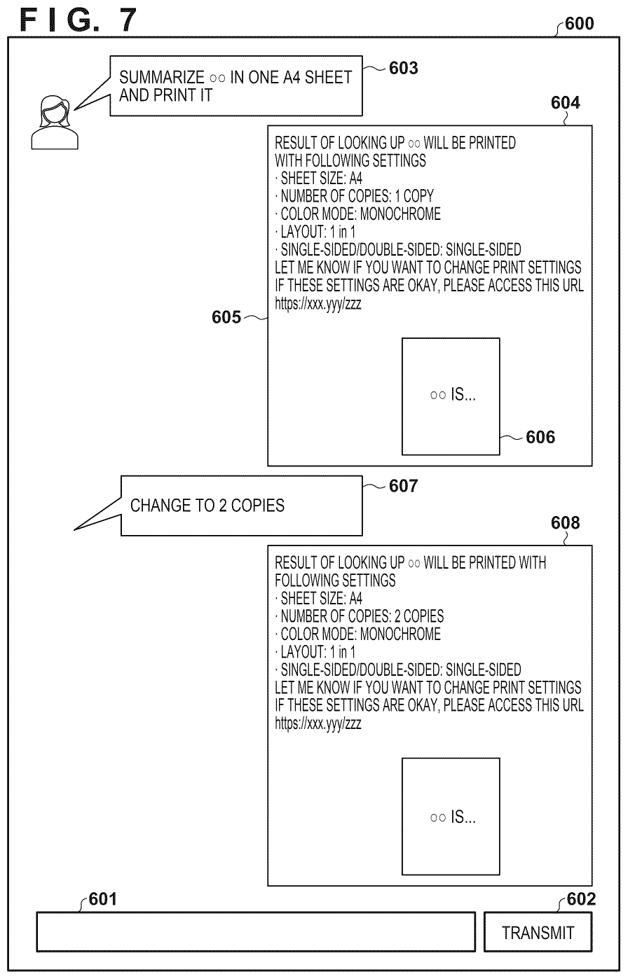

Interaction between the user and the generative AI server 30 for when instructing the generative AI server 30 to perform printing according to the present embodiment will be described with reference to FIG. 7. A screen 600 is displayed on the operation panel 201 by the generative AI server 30 being accessed from the browser operating on the user terminal 20.

A prompt input field 601 is an input field for the user to input instruction text (prompt) to the generative AI server 30. The user performs input in a natural language text format from the operation panel 201 of the user terminal 20. The user can input instruction text by operating a touch panel of the user terminal 20. The input of instruction text may be realized by voice input. A transmission button 602 is a trigger button for transmitting a prompt inputted to the prompt input field 601 to the generative AI server 30.

A print request prompt 603 is an example of a prompt for instructing the generative AI server 30 to perform printing. It needs to include a guideline for text to be generated by the generative AI server 30 and that it be printed.

A print request response 604 is a response to the print request prompt 603 generated by the generative AI server 30 in cooperation with the extension application server 40. Thereafter, interactive interactions between the user and the generative AI server 30 are arranged in chronological order in combinations of a prompt and a response. The print request response 604 includes settings for printing to be performed, and a reserved job URL 605 and a preview image 606, which will be described later.

The reserved job URL 605 is a URL indicating a print job stored in the cloud printing server 50, and is an example of information related to a connection destination. The information related to a connection destination is not limited to a URL, and may be any information so long as it is information indicating a location where the print job is stored or information for identifying the print job. By accessing this URL, the user can perform cloud printing (input of the print job from the cloud printing server 50 to the image forming apparatus 10). In addition, when changing print settings of a reserved job, an HTTP request is transmitted to the reserved job URL. The preview image 606 is a preview image representing an image of an output when printed with the current print settings. With this image, the user can get a rough idea of what the output will look like before printing.

A print setting change prompt 607 is an example of a prompt for instructing the generative AI server 30 to change a setting when the user wishes to change a print setting confirmed in the print request response 604. Regarding this instruction, the user also inputs the instruction in the prompt input field 601 and, by pressing the transmission button 602, transmits the instruction to the generative AI server 30. In the present embodiment, it is instructed to change the number of copies to two copies, but it may be instructed to change another setting (e.g., change the sheet size, set the layout to 2in1, etc.). In addition, an instruction for changing a plurality of settings may be included.

A print setting change response 608 is a response to the print setting change prompt 607 generated by the generative AI server 30 in cooperation with the extension application server 40. The basic content does not change from that of the print request response 604, but the instructed changes are reflected in the print settings. In addition, when settings such as the color mode or the layout that change the preview image are changed, the preview image 606 is also replaced.

### <Sequence>

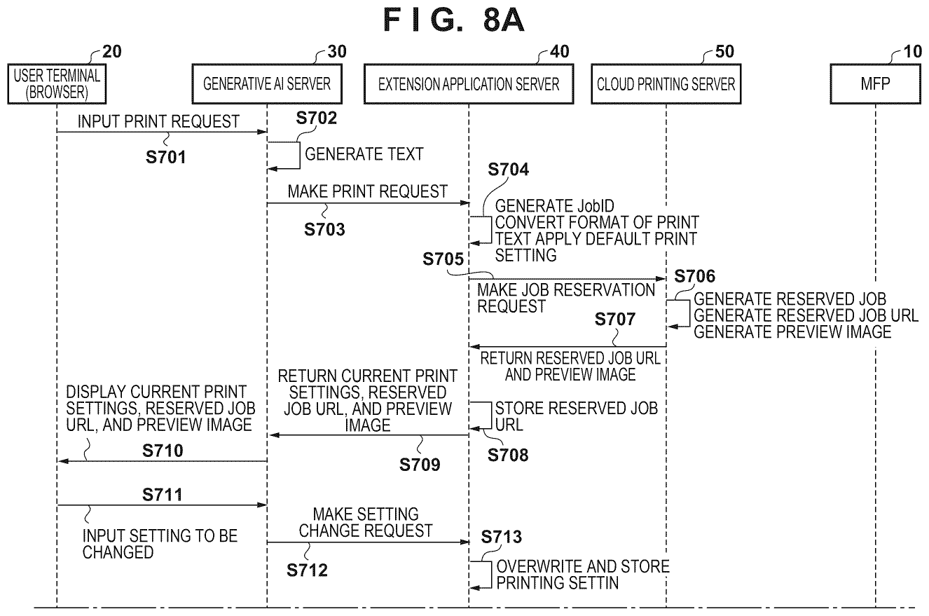

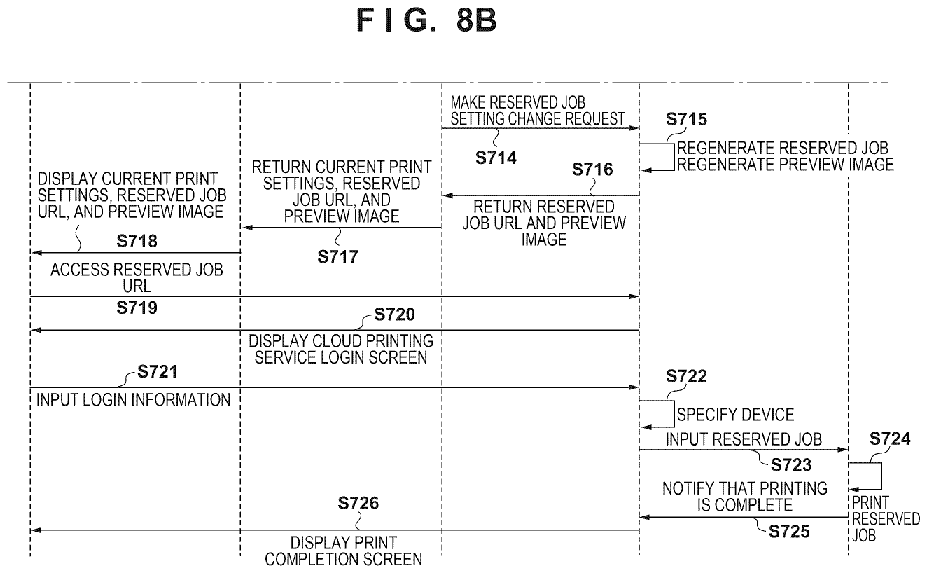

Interaction between constituent elements of the system from when the user instructs the generative AI server 30 to perform printing until when a print job is actually inputted to the image forming apparatus 10 according to the present embodiment will be described with reference to FIGS. 8A-8B. In the sequence to be described below, in a case where the generative AI server 30 and the extension application server 40 are provided in an integrated manner, control of the two apparatuses will be integrated.

In step S701, the user terminal 20 transmits the content of the print request prompt 603 to the generative AI server 30 according to a user operation through the browser. Then, the generative AI server 30, in step S702, generates text (text data) to be printed and, in step S703, transmits a print request to the extension application server 40. In step S703, the text data generated in step S702 is transmitted together.

Then, in step S704, the extension application server 40 generates and stores a JobID. The JobID is unique identification information for managing various kinds of data to be handled in the future in association with each other. In addition, the extension application server 40 converts the text data received from the generative AI server 30 to a format (e.g., PDF) that can be accepted by the cloud printing server 50. If the cloud printing server 50 can accept text data, this processing may be skipped. Then, the extension application server 40 stores default print settings as the current print settings. Then, in step S705, the extension application server 40 transmits a job reservation request to the cloud printing server 50. At this time, the converted data generated in step S704 and the current print settings are transmitted together.

In step S706, the cloud printing server 50 generates a reserved job based on the converted data and the current print settings received from the extension application server 40. Further, the cloud printing server 50 generates the reserved job URL 605 indicating the reserved job and the preview image 606, which is an output image of the reserved job, and stores them together with the generated reserved job. Then, in step S707, the cloud printing server 50 returns the reserved job URL 605 and the preview image 606 to the extension application server 40 as a response to the job reservation request.

Next, in step S708, the extension application server 40 stores the reserved job URL 605 in association with the JobID. Then, in step S709, the extension application server 40 returns, as information to be presented to the user, the current print settings, the reserved job URL 605, and the preview image 606 to the generative AI server 30 as a response to the print request. In step S710, the generative AI server 30 returns the current print settings, the reserved job URL 605, and the preview image 606 to the user terminal 20 as a response to the print request prompt 603. The user terminal 20 presents information to the user via the browser according to the received information.

In step S711, the user terminal 20 transmits the content of the print setting change prompt 607 to the generative AI server 30 according to user input through the browser. If a print setting does not need to be changed, steps S711 to S718 may be skipped. In step S712, the generative AI server 30 transmits a print setting change request to the extension application server 40. In step S713, the extension application server 40 reads the current print settings associated with the JobID and stores the setting changed according to the print setting change request (change content) by overwriting and updating the current print settings. In step S714, the extension application server 40 reads the reserved job URL associated with the JobID, transmits a reserved job setting change request to the cloud printing server 50, and performs a re-reservation. At this time, the extension application server 40 transmits the converted data generated in step S704 together with the current print settings overwritten in step S713.

In step S715, the cloud printing server 50 regenerates the reserved job and the preview image 606 with the new print settings and updates them. It is desirable that the reserved job URL 605 remains unchanged. With this, it is possible to externally indicate that it is the same reserved job. In step S716, the cloud printing server 50 returns the reserved job URL 605 and the regenerated preview image 606 to the extension application server 40 as a response to the reserved job setting change request.

In step S717, the extension application server 40 returns the print settings in which the change is reflected, the reserved job URL 605, and the regenerated preview image 606 to the generative AI server 30 as a response to the print setting change request. In step S718, the generative AI server 30 returns the current print settings in which the change is reflected, the reserved job URL 605, and the regenerated preview image 606 to the user terminal 20 as a response to the print request prompt 603.

Then, in step S719, the user terminal 20 accesses the reserved job URL 605 according to a user operation through the browser. In step S720, the cloud printing server 50 returns a login screen (not illustrated) of a cloud printing service to the user terminal 20. The user terminal 20 displays a login screen on the operation panel 201. In step S721, the user terminal 20 receives login information according to a user operation and logs in to the cloud printing service. If the user does not have a cloud printing service account, an account creation operation (not illustrated) will be necessary.

In step S722, the cloud printing server 50 specifies an MFP used by the user from the logged-in user information. If the user has not registered an MFP, an MFP registration operation (not illustrated) will be necessary. In addition, when a plurality of MFPs associated with the user information are registered, an MFP may be selected prior to printing through interactive communication with the user (not illustrated). In step S723, the cloud printing server 50 inputs the reserved job to the specified image forming apparatus 10.

In step S724, the image forming apparatus 10 executes printing according to the reserved job inputted from the cloud printing server 50. In step S725, the image forming apparatus 10 notifies the cloud printing server 50 that printing of the reserved job has been completed. In step S726, the cloud printing server 50 returns a print completion screen (not illustrated) to the user terminal 20 and causes the user terminal 20 to display it, and terminates the sequence.

### <Processing Procedure of Extension Application Server>

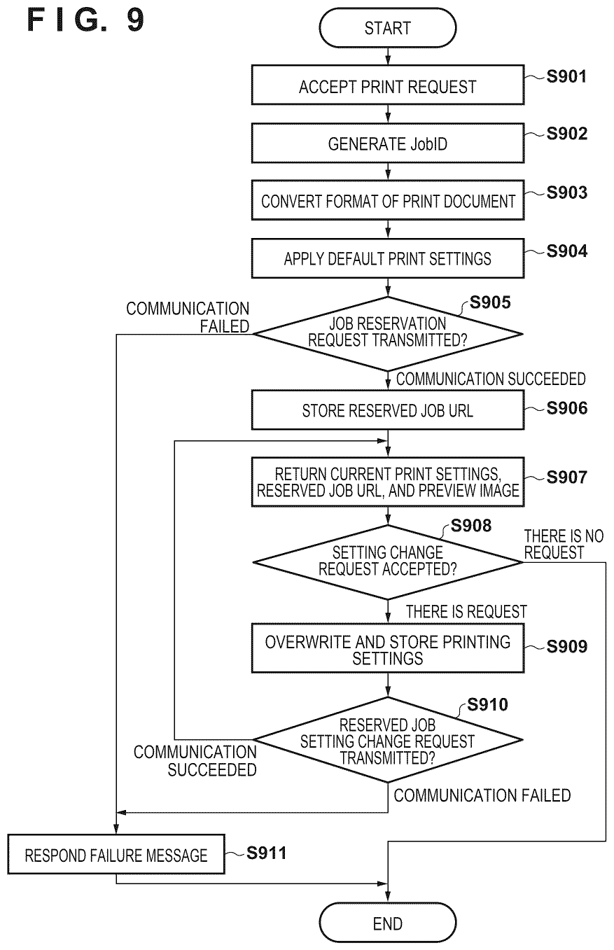

A processing procedure of the extension application server 40 according to the present embodiment will be described with reference to FIG. 9. The processing to be described below is realized, for example, by the CPU 401 reading a program stored in the ROM 402 to the RAM 403 and executing the program. Further, the following processing is realized by a plug-in that extends the functions of the generative AI server 30 being executed. In the present embodiment, the plug-in (program) will be described as being managed and executed by the extension application server 40, but it is not intended to limit the present invention. For example, the plug-in managed by the extension application server 40 may be installed in the generative AI server 30 and executed in the generative AI server 30. Alternatively, the generative AI server 30 and the extension application server 40 may be provided in an integrated manner, in which case the integrated server controls management, installation, and execution of the plug-in.

In step S901, the CPU 401 receives a print request and text data to be printed from the generative AI server 30. In step S902, the CPU 401 generates and stores a unique JobID. In step S903, the CPU 401 converts the text data to be printed into a format that can be accepted by the cloud printing server 50, generates print data, and stores the print data in a memory such as the RAM 403 or the HDD 405 in association with the JobID. The various storage processes to be described below are similarly performed on a memory such as the RAM 403 or the HDD 405. The memory may be connected to a unit external to the extension application server 40. In addition, in step S904, the CPU 401 reads the default print settings and stores them as the current print settings in association with the JobID.

Next, in step S905, the CPU 401 transmits a job reservation request to the cloud printing server 50. At this time, the CPU 401 transmits the converted print data and the current print settings together. If the communication succeeds and the reserved job URL 605 or the like is returned from the cloud printing server 50, the processing proceeds to step S906. Meanwhile, if there is an error notification from the cloud printing server 50 or when a response is not received within a predetermined period of time, it is determined that it has failed, and the processing proceeds to step S911.

In step S906, the CPU 401 stores the reserved job URL 605 in association with the JobID. In step S907, the CPU 401 returns the current print settings, the reserved job URL 605, and the preview image 606 to the generative AI server 30 as a response. In step S908, the CPU 401 determines whether a print setting change request has been received from the generative AI server 30. If a print setting change request has been received, the processing proceeds to step S909, and if a request has not been received, the processing of the flowchart is terminated.

In step S909, the CPU 401 reads the current print settings associated with the JobID and reflects and stores the requested setting change by overwriting. In step S910, the CPU 401 reads the reserved job URL 605 associated with the JobID, and transmits a reserved job setting change request to the cloud printing server 50. At this time, the CPU 401 transmits the converted print data and the print settings in which the change has been reflected together. If the communication succeeds and the reserved job URL 605 or the like is returned from the cloud printing server 50, the processing proceeds to step S907. Meanwhile, if the communication fails as described above, the processing proceeds to step S911. In step S911, the CPU 401 returns a failure message to the generative AI server 30, and terminates the processing of the flowchart.

As described above, the computer program (plug-in) according to the present embodiment is a computer program that extends the functions of the generative AI service. That is, upon receiving a print request through the generative AI service, the computer program causes a computer of the information processing apparatus to function so as to generate a print job based on the print request, and register reservation of the generated print job to the printing server. Further, the computer program causes the information processing apparatus to function so as to acquire information related to a connection destination for executing the reserved print job from the printing server, and present the print job generated via the generative AI service and information related to the connection destination to the user. With this, it is possible to reduce the time and effort it takes for printing text generated by the generative AI on the printing apparatus.

### Second Embodiment

A second embodiment of the present invention will be described below. In the above first embodiment, it has been described that in step S719, the user terminal 20 accesses the reserved job URL 605 according to a user operation through the browser. However, since the cloud printing server 50 is used by an unspecified number of users, it is not desirable to hold data of print jobs including reserved jobs indefinitely in view of effectively using memory resources. Therefore, it is desirable to set a validity period for a reserved job, and that the reserved job URL 605 inevitably follows that validity period. In the present embodiment, a method of reprinting for when the user accesses the reserved job URL 605 after the validity period has elapsed is described.

### <Derived Sequence>

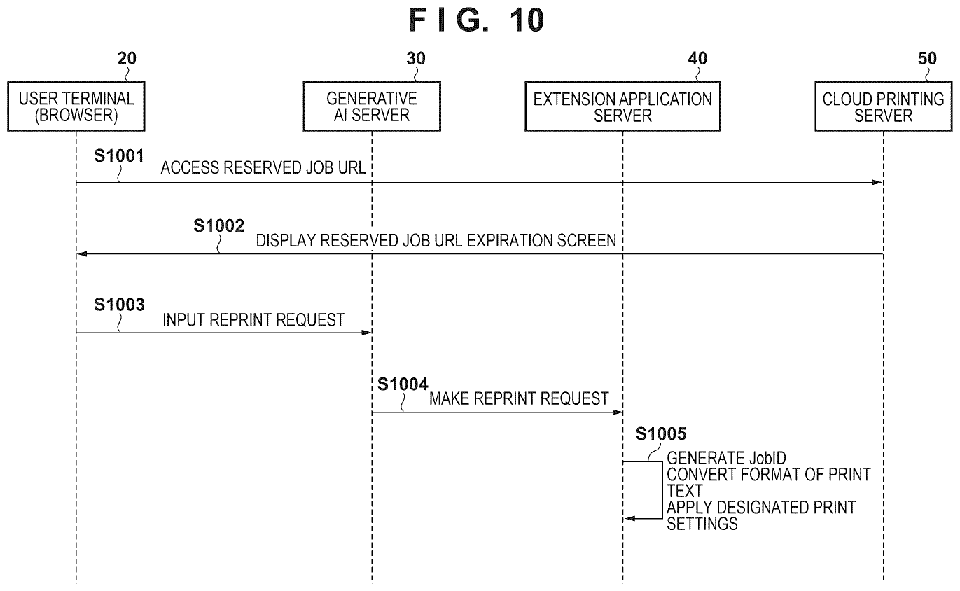

A derived sequence, for when the validity period of the reserved job URL 605 has elapsed, from the sequence diagram of FIGS. 8A-8B will be described with reference to FIG. 10. The processing up to step S718 is similar to that of FIGS. 8A-8B, and thus illustration and explanation thereof will be omitted.

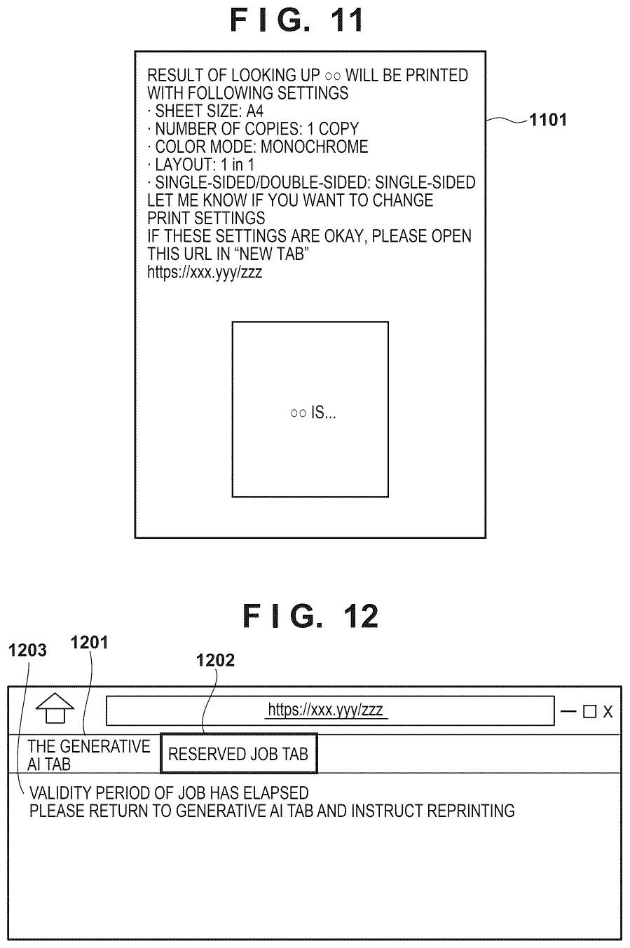

In step S1001, the user accesses the reserved job URL 605 in the browser. A difference from step S719 is that the user opens the reserved job URL 605 on a new tab in the browser. In addition, in order to guide the user to an operation of opening a new tab, the wording of the print request response 604 and the print setting change response 608 is partially changed as in a guidance response 1101 of FIG. 11.

In step S1002, the cloud printing server 50 returns a screen notifying that the reserved job URL 605 has expired to the user terminal 20. At this time, the display of the browser on the user terminal 20 is as in FIG. 12. A generative AI tab 1201 is a tab on which the screen of FIG. 7 is displayed in the browser up to step S718. In step S1002, the screen is not displayed, but all the interactions up to that of step S718 are stored, and will be displayed again when the user moves to the generative AI tab 1201. A reserved job tab 1202 is a tab newly opened by the user when accessing the reserved job URL 605. In step S1002, expiration text 1203 to be described later is displayed. The expiration text 1203 is text notifying the expiration of the reserved job URL 605, returned to the user terminal 20 by the cloud printing server 50. Text prompting the user to move to the generative AI tab 1201 in order to perform a print instruction again is also included.

In step S1003, the user terminal 20 moves to the generative AI tab 1201 according to user input, receives input of a reprint prompt, and transmits it to the generative AI server 30. In step S1004, the generative AI server 30 transmits a reprint request to the extension application server 40. The reprint request includes the text generated in step S702 and the print settings indicated in the print setting change response 608.

In step S1005, the extension application server 40 receives the reprint request. The processing content basically does not change from that of step S704, but instead of the default print settings, the print settings included in the reprint request are stored as the current print settings. That is, here, text previously generated in step S702 is read from the storage destination and used. Since a subsequent process is not different from that of step S705, description thereof will be omitted.

As described above, reservation of a print job in the cloud printing server according to the present embodiment is stored in the cloud printing server, and a validity period is set. Further, the computer program of the present invention further causes the information processing apparatus to function so as to store a generated print job. Further, when a validity period of reservation of a print job has expired, if a reprint request is received via the generative AI service, a re-reservation of that print job is registered in the printing server using the stored text and print settings. With this, according to the present embodiment, even when the reserved job URL 605 has expired, reprinting can be suitably performed without redoing it from the beginning.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-219984, filed Dec. 26, 2023 which is hereby incorporated by reference herein in its entirety.

What is claimed is:

1. A non-transitory computer-readable storage medium storing a computer program for extending a function of a generative AI service, wherein the computer program is for causing a computer of an information processing apparatus to function so as to:
upon accepting a print request via the generative AI service, generate a print job based on the print request;
register reservation of the generated print job in a printing server;
acquire information related to a connection destination for executing the reserved print job from the printing server; and
present the generated print job and the information related to the connection destination to a user via the generative AI service.

2. The storage medium according to claim 1, wherein
the computer program is further for causing the computer of the information processing apparatus to function so as to:
upon accepting a request to change a setting of the print job presented to the user via the generative AI service, update the print job and the reservation of the print job according to change content.

3. The storage medium according to claim 2, wherein
the reservation of the print job to the printing server is stored in the printing server, and a validity period is set.

4. The storage medium according to claim 3, wherein
the computer program is further for causing the computer of the information processing apparatus to function so as to:
store the generated print job; and
in a case where the validity period of the reservation of the print job has expired, when a reprint request is accepted via the generative AI service, register a re-reservation of the print job in the printing server using the stored print job.

5. The storage medium according to claim 1, wherein
the computer program is further for causing the computer of the information processing apparatus to function so as to:
present print setting content and a print preview image generated by the printing server to the user as information of the print job.

6. The storage medium according to claim 5, wherein
the computer program is further for causing the computer of the information processing apparatus to function so as to:
assign unique identification information when generating the print job.

7. The storage medium according to claim 6, wherein
the computer program is further for causing the computer of the information processing apparatus to function so as to:
convert text data included in the print request accepted via the generative AI service into a format that can be accepted by the printing server, and generate print data.

8. The storage medium according to claim 7, wherein
the computer program is further for causing the computer of the information processing apparatus to function so as to:
set a preset print setting for the generated print job.

9. The storage medium according to claim 5, wherein
in a case where the user accesses the information related to the connection destination presented to the user, the print job is inputted from the printing server to the image forming apparatus, and the print job is executed.

10. The storage medium according to claim 5, wherein
the computer program is implemented in the information processing apparatus as a plug-in of the generative AI service.

11. A print control method comprising:
upon accepting a print request via a generative AI service provided by an information processing apparatus, generating a print job based on the print request;
registering reservation of the generated print job in a printing server;
acquiring information related to a connection destination for executing the reserved print job from the printing server; and
presenting the generated print job and the information related to the connection destination to a user via the generative AI service.

12. A printing system including an information processing apparatus providing a generative AI service to a user terminal, a printing server, and an image forming apparatus,
the information processing apparatus comprising:
one or more first memory devices that store a set of instructions; and
one or more first processors that execute the set of instructions to:
upon accepting a print request via the generative AI service, generate a print job based on the print request;
register reservation of the generated print job in a printing server;
acquire information related to a connection destination for executing the reserved print job from the printing server; and
present the generated print job and the information related to the connection destination to a user via the generative AI service, and
the printing server comprising:
one or more second memory devices that store a set of instructions; and
one or more second processors that execute the set of instructions to:
when the print job is reserved, provide the information related to the connection destination; and
when the user accesses the information related to the connection destination, input the print job to the image forming apparatus.

13. The printing system according to claim 12, wherein
the one or more second processors execute instructions in the one or more second memory devices to: when the user accesses the information related to the connection destination presented to the user, provide a login screen to the user terminal, and based on user information inputted via the login screen, specify an image forming apparatus to which the print job is to be inputted.

14. The printing system according to claim 13, wherein
the one or more second processors execute instructions in the one or more second memory devices to: in a case where a plurality of image forming apparatuses are associated with the user information, query the user via the user terminal in advance for an image forming apparatus to be used.

15. The printing system according to claim 12, wherein
the printing server is a cloud printing server.
